(19) United States
(12) Patent Application Publication
(10) Pub. No.: US 2003/0043029 A1
(43) Pub. Date: Mar. 6, 2003

(54) On-vehicle infrared image display unit

(75) Inventors: Takashi Ichikawa, Aichi (JP); Michimasa Ito, Aichi (JP)

Correspondence Address: David M. Crompton, CROMPTON, SEAGER & TUFTE, LLC, Suite 895, 331 Second Avenue South, Minneapolis, MN, 55401-2246, US

(73) Assignee: Kabushiki Kaisha Tokai Rika Denki Seisakusho

(21) Appl. No.: 10/224,192

(22) Filed: Aug. 20, 2002

(30) Foreign Application Priority Data
Aug. 31, 2001 (JP) 2001-262913

(51) Int. Cl. B60Q 1/00

(52) U.S. Cl. 340/435; 340/691.1; 348/148; 345/7

(57) ABSTRACT

A portable device is detachably attached to the dashboard of a vehicle. The image of the condition outside the vehicle is taken by an infrared camera. The taken image is shown on a display, which is part of the portable device. The infrared image shown on the display is projected onto a translucent screen.

### BACKGROUND OF THE INVENTION

The present invention relates to an on-vehicle infrared image display unit that displays infrared images using far infrared rays radiated from subjects.

During night driving, a driver uses the headlights for illuminating the road ahead to see the condition of the road. In addition to the headlights, some recent vehicles are equipped with an infrared device to confirm the condition of the road ahead.

Japanese Laid-Open Patent Publication No. 6-48247 discloses an on-vehicle infrared image display unit. The display unit includes a display for showing infrared images captured by an infrared camera. The display is embedded in the dashboard of a vehicle during manufacture. An infrared camera unit captures images and generates image data. Based on the image data, the display shows infrared images. The infrared images are vertically projected by a reflector. Then, the images are reflected on the windshield through a projection opening formed in the dashboard.

The windshield is used as a screen. That is, infrared images are projected on part of the windshield. The driver therefore looks at the road ahead illuminated by the headlights and the infrared images projected onto the windshield. This permits the driver to confirm the road condition during night.

However, since the display and the reflector are embedded in the dashboard during manufacture, the installment of the display unit is complicated. If the display and the reflector are embedded in the dashboard after the manufacture of a vehicle, the installment is further complicated. Therefore, there is a demand for an infrared display unit that is easily installed in a vehicle.

Also, in addition to the reflector, the above display unit requires brackets to support the display and the reflector, which increases the number of parts. As a result, the cost is considerably increased, and the inner structure of the dashboard is complicated.

In addition, wiring harnesses that are connected to junction blocks are stringed around the interior of the dashboard. Therefore, it is difficult to reduce the size of the dashboard and to make room for the display and the reflector at the same time.

### SUMMARY OF THE INVENTION

Accordingly, it is an objective of the present invention to provide an infrared display unit that is easily installed in a vehicle at a low cost.

To achieve the foregoing and other objectives and in accordance with the purpose of the present invention, an on-vehicle infrared image display unit is provided. The unit takes an image of the condition outside a vehicle with an infrared camera and shows the taken image in the vehicle. The unit includes a portable device, a display, a translucent screen, and a dashboard. The display shows the infrared image taken by the infrared camera. The display is a portion of the portable device. The infrared image shown on the display is projected onto the translucent screen. The dashboard is located inside the vehicle. The portion of the portable device including the display is detachably attached to the dashboard.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a location of an infrared camera in a vehicle;

FIG. 2 is a perspective view illustrating the interior of a vehicle in which a notebook computer is installed;

FIG. 3 is a perspective view illustrating the interior of a vehicle from which a notebook computer is demounted;

FIG. 4 is a schematic perspective view showing a pivoting direction of the display of a notebook computer;

FIG. 5 is a perspective view showing the connection between a notebook computer and a computer receptacle;

FIG. 6 is a diagram showing the electric construction of an on-vehicle infrared image display unit; and

FIG. 7 is a diagram showing an example of an infrared image on a display.

### DETAILED DESCRIPTION OF THE PREFERRED EMBODIMENTS

One embodiment of the present invention will now be described with reference to the drawings.

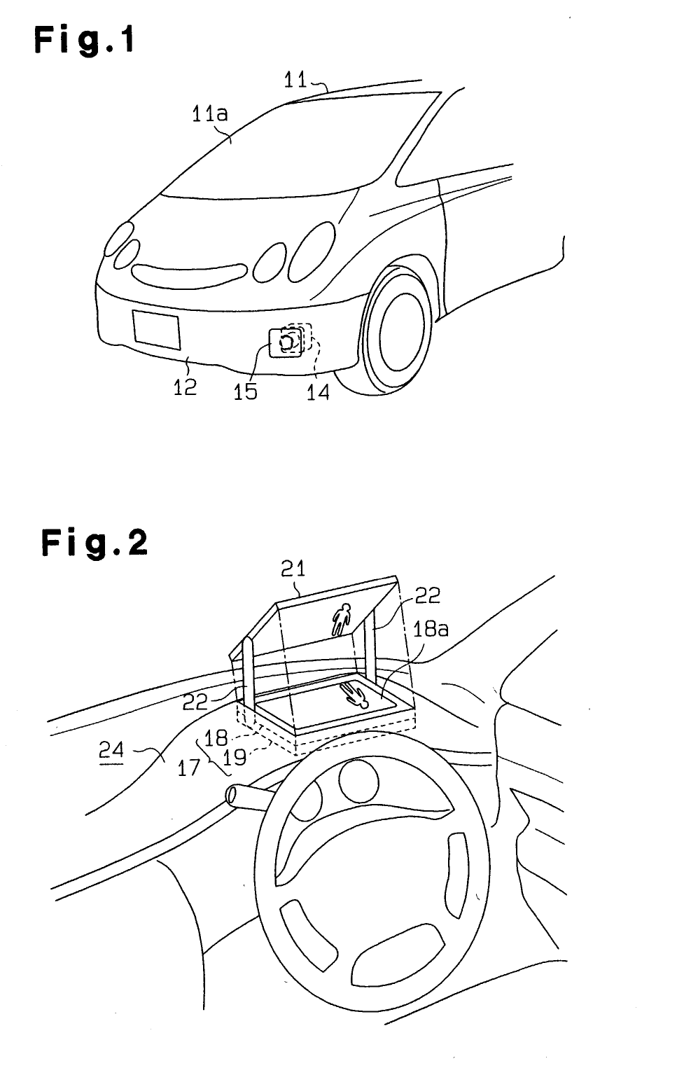

As shown in FIG. 1, an infrared camera 14 is embedded in a front bumper 12 of a vehicle 11. The infrared camera 14 captures the condition of the road through a window 15 formed in the bumper 12. The infrared camera 14 is an uncooled type, which requires no cooling medium (liquid nitrogen, argon gas) for cooling the infrared sensors inside. Thus, the infrared camera 14 requires no maintenance typical of infrared cameras. Although the maintenance free advantage cannot be obtained, a cooled type infrared camera may be used as the infrared camera 14.

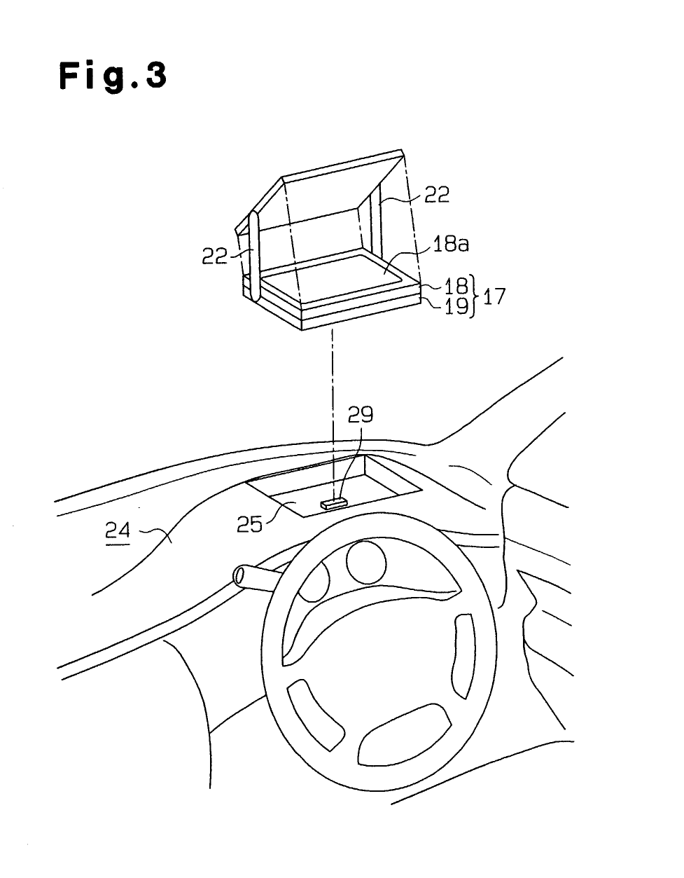

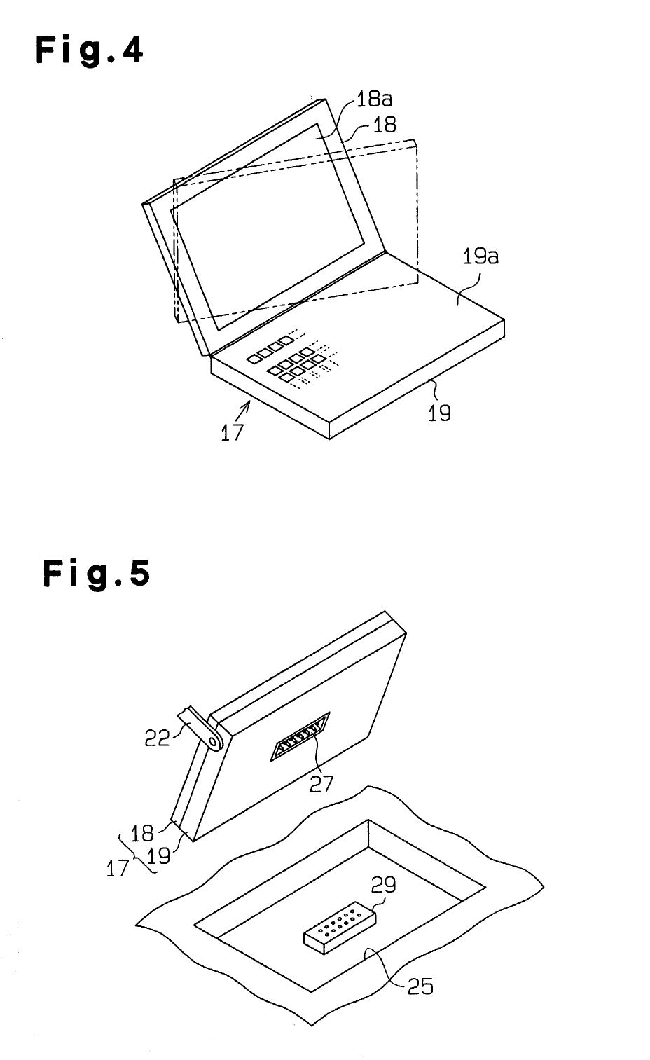

As shown in FIGS. 2 and 3, an image captured by the infrared camera 14 is shown on a display 18 of a notebook computer 17 located in the passenger compartment of the vehicle 11. As shown by solid line in FIG. 4, the display 18 is pivotable frontward and rearward about the front end of a main body 19 of the computer 17. As shown by alternate long and two short dashes line in FIG. 4, the display 18 is also pivotable about an axis perpendicular to a keyboard surface 19a of the main body 19. Therefore, the front side and the rear side of the display 18 selectively faces the main body 19. When the computer 17 is used as part of the display unit, the rear side of the display 18 is arranged to face the main body 19.

The computer 17 includes a translucent screen 21 made of synthetic resin. The screen 21 is supported by support members 22. One end of each support member 22 is pivotally attached to the computer 17. The other end of each support member 22 is pivotally attached to the screen 21. The support members 22 allow the screen 21 to pivot relative to the display 18. In other words, the angle of the screen 21 relative to a display surface 18a is adjustable.

Infrared image of the display 18 is projected onto the translucent screen 21. The mirror image of the display 18 is shown on the screen 21. Since the screen 21 is translucent, the image of the display 18 is overlaid on the view of the road ahead illuminated by the headlights.

The support members 22 can be detached from the computer 17. When the computer 17 is not used as the infrared image display unit, the screen 21 is detached from the computer 17. The computer 17 may be placed in a computer receptacle 25 with the screen 21 detached. In this case, the infrared image of the display 18 is projected onto the inner surface of a windshield 11a.

As shown in FIGS. 3 and 5, the computer receptacle 25 is formed in the upper surface of a dashboard 24. The computer 17 is detachably fitted in the receptacle 25. The projected area of the receptacle 25 is substantially equal to that of the computer main body 19. The depth of the receptacle 25 is substantially equal to the thickness of the computer 17. Thus, the display surface 18a of the display 18 is substantially flush with the upper surface of the dashboard 24. Therefore, when placed on the dashboard 24, the computer 17 appears integrated with the dashboard 24 and has a superior appearance. The use of the computer 17 is not limited to the infrared image display unit. When detached from the receptacle 25, the computer 17 can be used as an ordinary computer.

As shown in FIG. 5, a male connector 27 having pins is embedded in the main body 19. The pins of the male connector 27 are exposed at the lower surface of the computer main body 19. A female connector 29 is located in the receptacle 25 on the dashboard 24. The female connector 29 can be connected to the male connector 27. Part of the female connector 29 projects from the bottom of the receptacle 25. When the computer 17 is fitted in the receptacle 25, the connectors 27, 29 are electrically connected to each other.

The electric structure of the infrared image display unit will now be described.

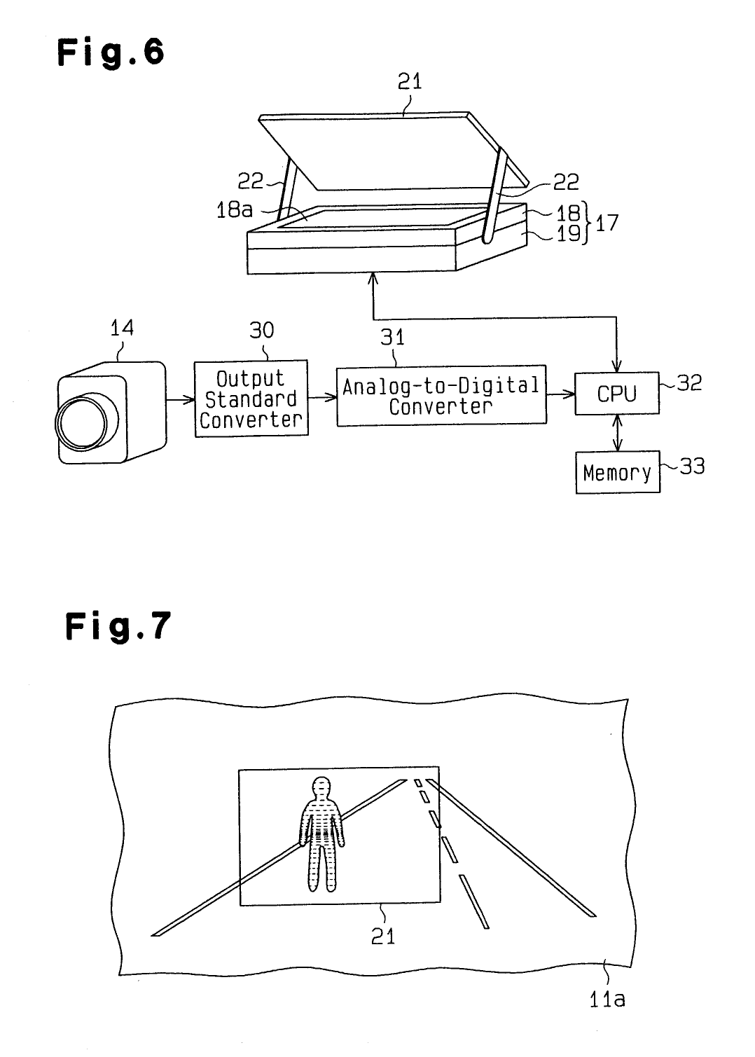

As shown in FIG. 6, the infrared camera 14 is connected to an on-vehicle CPU 32 via an output standard converter 30 and an analog-to-digital converter 31. The standard converter 30 converts the output of the infrared camera 14 from the NTSC standard to the VGA standard. As widely known, NTSC stands for National Television Standards Committee and refers to the name of a standard developed by the committee, which develops standards of analog terrestrial collar television broadcast. On the other hand, VGA stands for Video Graphics Array and refers to a standard for output to computers of IBM.

The output terminal of the on-vehicle CPU 32 is connected to the CPU (not shown) of the computer 17. Data are bidirectionally transmitted between the CPU of the computer 17 and the on-vehicle CPU 32. The on-vehicle CPU 32 is connected to a memory 33, which stores programs for operating the infrared image display unit.

The on-vehicle CPU 32 displays a mirror image of an infrared image of a subject captured by the infrared camera 14 on the display surface 18a. Thus, the image on the screen 21 is identical with the image before being reversed.

Based on the programs stored in the memory 33, the on-vehicle CPU 32 judges whether the infrared image of the subject captured by the infrared camera 14 satisfies a predetermined condition. In this embodiment, the predetermined condition refers to whether the heat emitted by the subject is in the range of thirty to forty decrees centigrade. The temperature range is determined to detect subjects the temperature of which is close to the temperature of humans and animals. This allows life forms to be distinguished from the other subjects. The temperature range may be set arbitrarily.

Based on the programs stored in the memory, the on-vehicle CPU 32 displays subjects that satisfy the predetermined condition in a color that is different from a color used for subjects that do not satisfy the predetermined condition. Specifically, the subjects the temperature of which is in the range between thirty to forty degrees centigrade are shown in red (shown by broken lines in FIG. 7). The subjects that are not in the temperature range are shown in monochrome. Thus, life forms are shown in red and the other subjects are shown in monochrome. The reason for using red for life forms is that a warm color is prominent.

As described above, the image of subjects satisfying the predetermined condition is distinguished from the other subjects based on the color difference. Particularly, in this embodiment, subjects satisfying the predetermined condition are more prominent than other subjects in the infrared image. The color for showing the subjects satisfying the predetermined condition and the color for showing the other subjects may be changed as long as the colors are distinguishable from each other.

To install the computer 17 in the dashboard 24 of the vehicle 11, the computer main body 19, to which the screen 21 is attached, is fitted in the receptacle 25. At the same time, the male connector 27 of the main body 19 is connected to the female connector 29 of the receptacle 25. Then, the angle of the screen 21 relative to the display surface 18a of the display 18 is adjusted.

To remove the computer from the dashboard 24, the main body 19 is pulled out of the receptacle 25. Accordingly, the connectors 27, 29 are disconnected. Thereafter, the screen 21 is removed from the main body 19. After being removed from the dashboard 24, the computer 17 can be used for ordinary purposes.

Since the notebook computer 17 is mounted on the upper surface of the dashboard 24, the space for the computer 17 is easily obtained. Also, the computer 17 need not be embedded in the dashboard 24. Thus, even after the vehicle is manufactured, the computer 17 can be easily installed in the vehicle.

The display unit of this embodiment requires no members such as brackets for attaching a reflector to the computer 17. Therefore, the number of the parts in the display unit is reduced, which reduces the cost.

The angle of the translucent screen 21 provided on the main body 19 relative to the display surface 18a is adjustable. Therefore, regardless of the angle of the windshield 11a and the shape of the dashboard 24, which vary depending on the model of vehicles, infrared images are reflected on the screen 21 at an appropriate angle. In other words, the infrared images are always clearly shown.

Subject having a temperature in the range between thirty and forty degrees centigrade are shown in red on the display 18. Other subjects are shown in monochrome. This allows life forms such as humans and animals to be easily distinguished from other subjects. The driver can therefore grasp the condition of the road ahead at night. The display unit therefore significantly contributes to prevention of traffic accidents at night.

It should be apparent to those skilled in the art that the present invention may be embodied in many other specific forms without departing from the spirit or scope of the invention. Particularly, it should be understood that the invention may be embodied in the following forms.

The receptacle 25 for receiving the computer 17 may be omitted from the dashboard 24. In this case, engagement projections are formed either on the computer 17 or the dashboard 24, and corresponding recesses are formed in the other one of the computer 17 and the dashboard 24. The computer 17 is attached to the dashboard 24 by engaging the projection with the recesses.

The image of subjects that satisfy the predetermined condition may be displayed in manners other than that disclosed in the above embodiment. For example, the subjects satisfying the condition may be processed by the on-vehicle CPU 32 and represented by graphic symbols or characters. In this case, the graphic symbols and the characters may be shown in a color different from the color showing other subjects. Accordingly, subjects satisfying the predetermined condition are more distinctly displayed.

All or part of the processes performed by the on-vehicle CPU 32 may be performed by the CPU of the computer 17. Instead of connecting the on-vehicle CPU 32 with the notebook computer 17 by the connectors, the CPU 32 and the computer 17 may be communicated with each other wirelessly. The wireless communication may be performed by Bluetooth or standards specified by Infrared Data Association (IrDA).

Instead of the computer 17 having the display 18 integrated with the body 19, a computer having a display separated from the body may be used. In this case, the display and the body communicate wirelessly. If such a computer is used, only the light display needs to be attached to the dashboard 24. Therefore, the computer is easily installed in the receptacle 25.

The translucent screen 21 may be omitted, and the infrared image of the display 18 may be directly projected onto the windshield 11a of the vehicle 11.

In the illustrated embodiment, the subjects are distinguished based on the range of the temperatures of the subjects. However, the subjects may be distinguished based on other reference. For example, the subjects may be distinguished based on the distance between each subject and the vehicle 11. In this case, an ultrasonic distance sensor is provided in the front portion of the vehicle 11 to measure the distance between the vehicle 11 and subjects. The images of subjects that are located within a predetermined distance from the vehicle 11 are colored for calling attention of the driver.

Therefore, the present examples and embodiments are to be considered as illustrative and not restrictive and the invention is not to be limited to the details given herein, but may be modified within the scope and equivalence of the appended claims.

What is claimed is:

1. An on-vehicle infrared image display unit, wherein the unit takes an image of the condition outside a vehicle with an infrared camera and shows the taken image in the vehicle, the unit comprising:
a portable device;
a display for showing the infrared image taken by the infrared camera, said display being a portion of the portable device, ;
a translucent screen, onto which the infrared image shown on the display is projected; and
a dashboard located inside the vehicle, wherein the portion of the portable device including the display is detachably attached to the dashboard.

2. The display unit according to claim 1, wherein the translucent screen is attached to the portable device, and wherein the angle of the translucent screen is adjustable relative to the display.

3. The display unit according to claim 1, wherein the portable device includes a personal computer.

4. The display unit according to claim 1, said dashboard having an upper surface that includes a receptacle for receiving the personal computer, wherein the size of the receptacle conforms to the personal computer, and wherein the display has an surface that is flush with the upper surface of the dashboard.

5. The display unit according to claim 4, further comprising a female connector located in the receptacle, and a male connector provided with the computer, wherein the male connector is electrically connected to the female connector.

6. The display unit according to claim 5, further comprising:
a CPU located in the vehicle and connected to the infrared camera and the female connector; and
a memory located in the vehicle and connected to the CPU, wherein, when the male connector of the personal computer is connected to the female connector, the CPU controls the personal computer according to a program previously stored in the memory, and the infrared image taken by the infrared camera is shown on the display in a predetermined mode.

7. The display unit according to claim 6, wherein, when a subject the image of which-is taken by the infrared camera satisfies a predetermined condition, the CPU shows infrared image of the subject in a different manner on the display.

8. The display unit according to claim 7, wherein the CPU distinguishes the infrared image of a subject when the temperature of the subject is in a predetermined range.

9. The display unit according to claim 8, wherein the CPU shows the image of a subject in a warm color when the temperature of the subject is in the predetermined range.

10. An on-vehicle infrared image display unit, wherein the unit takes an image of the condition outside a vehicle with an infrared camera and shows the taken image in the vehicle, the unit comprising:
a personal computer;
said computer having for showing the infrared image taken by the infrared camera;
a translucent screen, onto which the infrared image shown on the display is projected, wherein the translucent screen is attached to the personal computer, and wherein the angle of the translucent screen is adjustable relative to the display; and
a dashboard located inside the vehicle, wherein a portion of the personal computer including the display is detachably attached to the dashboard.

11. The display unit according to claim 10, said dashboard having an upper surface that includes a receptacle for receiving the personal computer, wherein the size of the receptacle conforms to the personal computer, and wherein the display has a surface that is flush with the upper surface of the dashboard.

12. The display unit according to claim 11, further comprising a female connector located in the receptacle and a male connector provided with the personal computer, wherein the male connector is electrically connected to the female connector.

13. The display unit according to claim 12, further comprising:
a CPU located in the vehicle and connected to the infrared camera and the female connector; and
a memory located in the vehicle and connected to the CPU;
wherein, when the male connector of the personal computer is connected to the female connector, the CPU controls the personal computer according to a program previously stored in the memory, and the infrared image taken by the infrared camera is shown on the display in a predetermined mode.

14. The display unit according to claim 13, wherein, when a subject the image of which is taken by the infrared camera satisfies a predetermined condition, the CPU shows the infrared image of the subject in a different manner on the display.

15. The display unit according to claim 14, wherein the CPU distinguishes the infrared image of a subject when the temperature of the subject is in a predetermined range.

16. The display unit according to claim 15, wherein the CPU shows the image of a subject in a warm color when the temperature of the subject is in the predetermined range.

17. An on-vehicle infrared image display unit, wherein the unit takes an infrared image of the condition outside a vehicle with an infrared camera and shows the taken infrared image in the vehicle, the unit comprising:
a display for showing the infrared image of a subject taken by an infrared image taking means;
a translucent screen, onto which the infrared image is projected;
distinguishing means for distinguishing infrared images based on a predetermined condition; and
image controlling means for showing the distinguished infrared image in a different manner on the display.

18. The display unit according to claim 17, wherein the distinguishing means distinguishes the infrared image of a subject when the temperature of the subject is in a predetermined range.

19. The display unit according to claim 18, wherein the distinguishing means shows the image of a subject in a warm color when the temperature of the subject is in the predetermined range.
